(19) United States
(12) Patent Application Publication
(10) Pub. No.: US 2007/0029004 A1
(43) Pub. Date: Feb. 8, 2007

(54) Apparatus and method for handling particulate material

(76) Inventor: Kyu R. Rhee, Federal Way, WA (US)

Correspondence Address: Barnard Intellectual Property, Inc., P.O. Box 58888, Seattle, WA, 98138-1888, US

(21) Appl. No.: 11/197,946

(22) Filed: Aug. 5, 2005

(51) Int. Cl. B67C 3/26

(52) U.S. Cl. 141/256

(57) ABSTRACT

Toner or other finely divided particulate material (44) is moved downwardly through a hopper (10) to an outlet at the lower end of the hopper and from the outlet into the inlet of an elevating conveyor (12) that is positioned sideways adjacent the hopper (10). The elevating conveyor (12) is operated to lift the particulate material (44) upwardly through the elevating conveyor (12) to a discharge spout (48). The particulate material (44) is discharged from the discharge spout (48) into another container (50). A vibrator (42) may be attached to the hopper (10) for vibrating the hopper (10) while delivering particulate material (44) downwardly through it. A pouring container (50) is provided that has an inlet (56) and a pouring spout (60). The inlet (56) of the pouring container (50) is placed under the discharge spout (48) of the elevating conveyor (12). The particulate material (44) is discharged from the discharge spout (48) of the elevating conveyor (12) into the inlet of the pouring container (50). Then, the particulate material (44) is poured out from the pouring container (50), through a pouring spout (60), into a receiving container (64). A vibrator (62) may be attached to the pouring container (50) to assist movement of particulate material (44) out from the pouring container (50) into the receiving container (64).

### TECHNICAL FIELD

This invention relates to an apparatus and method for storing and conveying finely divided particulate material such as toner that is used in laser printers, copying machines, and the like. More particularly, it relates to the provision of an apparatus and method for filling cartridges, and other containers, with toner, in a fast, easy and economical way.

### BACKGROUND OF THE INVENTION

Prior art devices and methods for dispensing toner and other finely divided particulate material are disclosed in the following U.S. patents: U.S. Pat. No. 3,664,385, granted May 23, 1972, to Clarence F. Carter; U.S. Pat. No. 4,305,529, granted Dec. 15, 1981, to Charles W. Spehrley Jr.; U.S. Pat. No. 4,611,921, granted Sep. 16, 1986, to Jiterdna A. Patel; U.S. Pat. No. 6,000,446, granted Dec. 14, 1999, to Paul M. Wegman, Mikhail Vaynshteyn and Charles J. Balistere; and U.S. Pat. No. 6,722,406, granted Apr. 20, 2004, to Paul M. Wegman and Mikhail Vaynshteyn. The contents of these patents are hereby incorporated herein to provide a background of the invention.

A problem with the prior art devices for handling and feeding toner is that they take up substantial space, are costly, and are relatively difficult to operate and clean. Accordingly, there is a need for an improved apparatus and method for handling bulk toner and other finely divided particular material that is easy to operate, easy to clean, is compact enough to sit on a work bench or cart, is affordable, and can efficiently fill toner cartridges or the like of many sizes. The principal object of the present invention is to fulfill this need.

### BRIEF SUMMARY OF THE INVENTION

The particulate material handling apparatus of the present invention includes a material storing hopper that delivers material downwardly to a lower outlet which is connected to an inlet at the lower end of an elevating screw conveyor that has a discharge spout at its upper end. Particulate material is fed downwardly through the hopper, out of the hopper through the outlet, into the inlet of an elevating screw conveyor, and is moved upwardly by the screw conveyor to an outlet spout. A container that is to receive the material is positioned under the outlet spout when the machine is being operated.

The preferred embodiment of the invention includes an elevating conveyor that is sideways adjacent to the hopper. The discharge spout of the elevating conveyor is closer to the upper end of the hopper than it is to the lower end of the hopper.

Other features that are in the preferred embodiment are a conveying screw in the hopper that is operable to move particulate material downwardly in the hopper to a lower end outlet, a vibrator attached to the hopper for vibrating the hopper, and a screw in the elevating conveyor that is rotatable for a lifting particulate material upwardly from the inlet of the elevating conveyor to the discharge spout. A pouring container may be provided that has an inlet and a pouring spout. The inlet is placed below the discharge spout of the elevating conveyor and the elevating conveyor is operated to deliver particulate material into the pouring container. The pouring container includes a pouring spout through which particulate material is poured into a receiving container. A vibrator may be attached to the pouring container. When the particulate material is toner, the receiving container may be a toner cartridge.

Other objects, advantages and features of the invention will become apparent from the description of the best mode set forth below, from the drawings, from the claims and from the principles that are embodied in the specific structures that are illustrated and described.

### BRIEF DESCRIPTION OF THE SEVERAL VIEWS OF THE DRAWINGS

Like reference numerals are used to designate like parts throughout the several views of the drawing, and:

FIG. 1 is an elevational view of a preferred embodiment of the invention, such view looking towards the elevating conveyor that is on one side of the hopper;

FIG. 2 is a side elevational view looking towards the right side of FIG. 1, such view showing a support for receiving a pouring dispenser and showing the pouring dispenser in phantom lines;

FIG. 3 is a sectional view taken substantially along line 3-3 of FIG. 1;

FIG. 4 is a side elevational view of the pouring container; and

FIG. 5 is a fragmentary view showing the pouring container being used to pour toner into a cartridge.

### DETAILED DESCRIPTION OF THE ILLUSTRATED EMBODIMENT

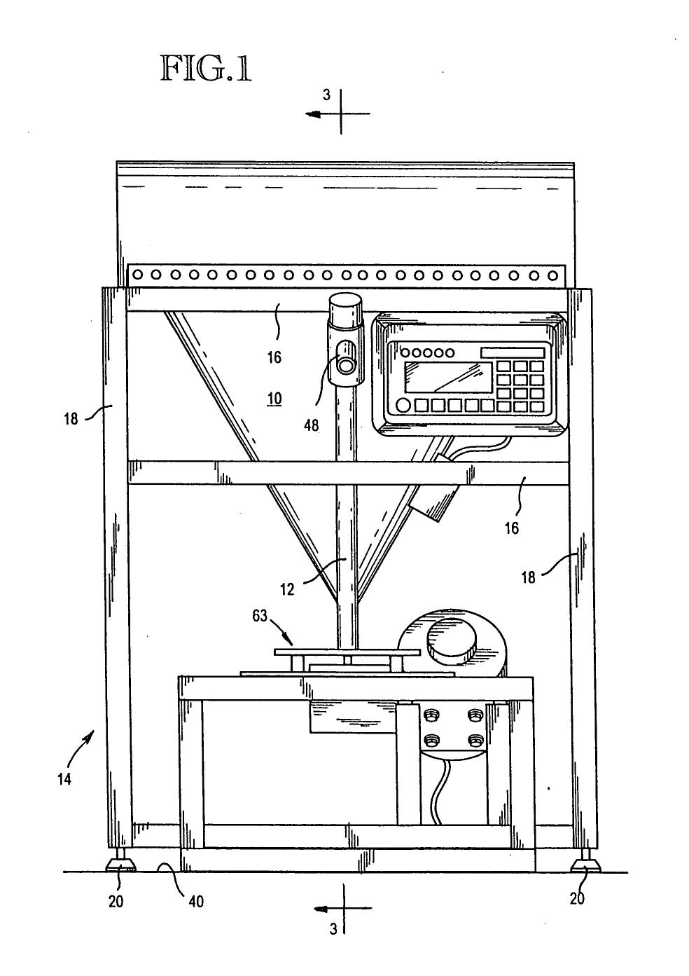

Referring to FIGS. 1-3, the illustrated embodiment of the invention comprises a hopper 10, an elevating conveyor 12 and a frame 14. By way of non-limitive example, the frame 14 may be formed from horizontal and vertical frame members 16, 18. The vertical frame members 18 may be corner posts and the horizontal members 16 may be members which extend between and interconnect the corner post 18. The frame 14 may have adjustable feet 20 at its lower four corners. Of course, the frame 14 may be constructed in a number of other ways than what is illustrated. The exact construction of frame 14 is not essential to the present invention.

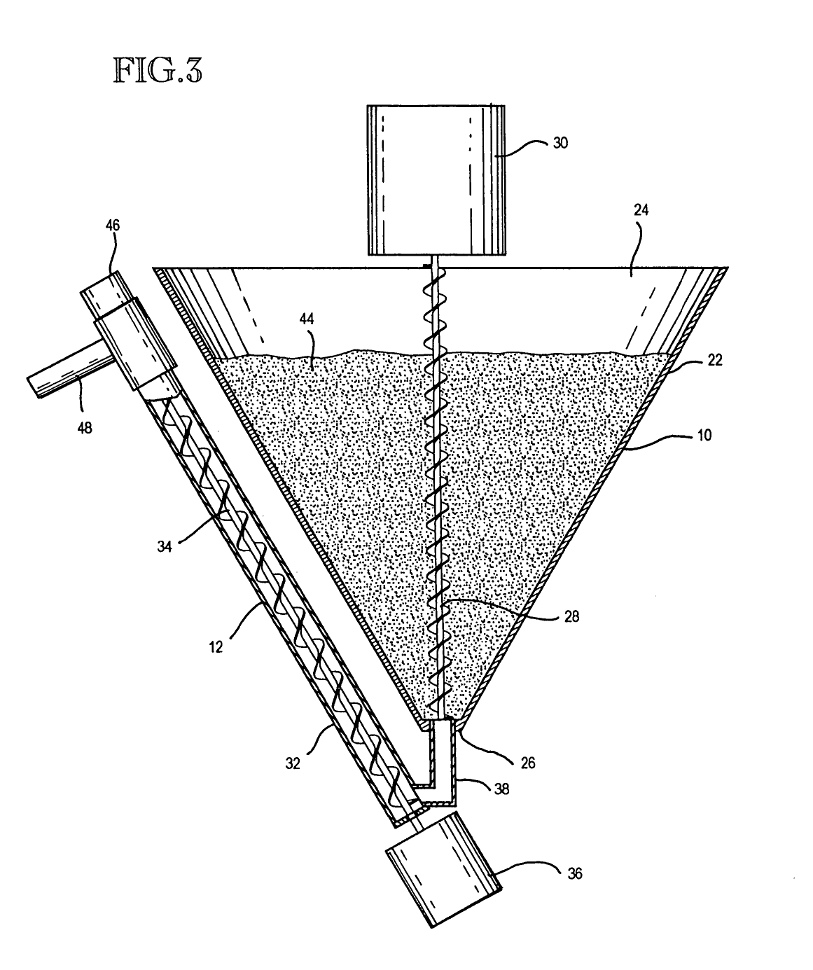

Referring to FIG. 3, the hopper 10 has a conical sidewall 22 that converges downwardly from an upper end inlet 24 to a lower end portion 26. A conveying screw 28 is preferably positioned within the hopper 10. In the illustrated embodiment, the conveying screw 28 is rotated by a motor 30 that is connected to the upper end of the conveying screw 28. In another embodiment, it may be desirable to attach the drive motor 30 to the lower end of the conveyor screw 28. The elevating conveyor 12 preferably comprises a tubular body 32 in which a conveying screw 34 is situated. In the illustrated embodiment, the lower end of the conveying screw 34 is attached to a drive motor 36 which rotates the conveying screw 34. In another embodiment, the drive motor may be attached to the upper end of the conveying screw 34. A connecting tube 38 extends from an outlet in the lower end portion 26 of the hopper 10 to an inlet in the lower end portion of the tubular body 32. The elevating conveyor 12 is sideways adjacent the hopper 10. Its upper end 46 is closer to the upper end of the hopper 10 than it is to the lower end portion of the hopper 10. Thus, the hopper 10 and the elevating conveyor 12 are compactly packaged together, substantially within the same vertical and horizontal space. This allows the hopper 10 and the elevating conveyor 12 to be mounted on a table or a short distance above a floor or other supporting surface 40.

In preferred form, a vibrator 42 (FIG. 1) is attached to the sidewall 22 of the hopper 10. Finely divided particulate material 44 is located inside of the hopper 10. It is introduced into the hopper 10 through the inlet 24. The conveying screw 28 is oriented to when rotated move the particulate material 14 downwardly in the hopper 10 towards the bottom end outlet and the connection tube 38. The vibrator 42 may be operated to vibrate the sidewall 22 and facilitate downward movement of the toner 44 while maintaining it in a substantially compacted state. The material 44 is moved out from the outlet and through the connector tube 38 into the inlet of the elevating conveyor 12. The conveying screw 34 is adapted to when rotated move the material upwardly through the tubular body 32, to a discharge spout 48 that extends downwardly and outwardly from an upper end portion of the tube 32.

In operation, a container, e.g. a toner cartridge, may be positioned with its inlet under the discharge spout 48. Then, the convener screws 28, 34 and the vibrator 42 (FIG. 1), when used, are operated to move toner 44 into the discharge spout 48 and from the discharge spout 48 into the receiving container.

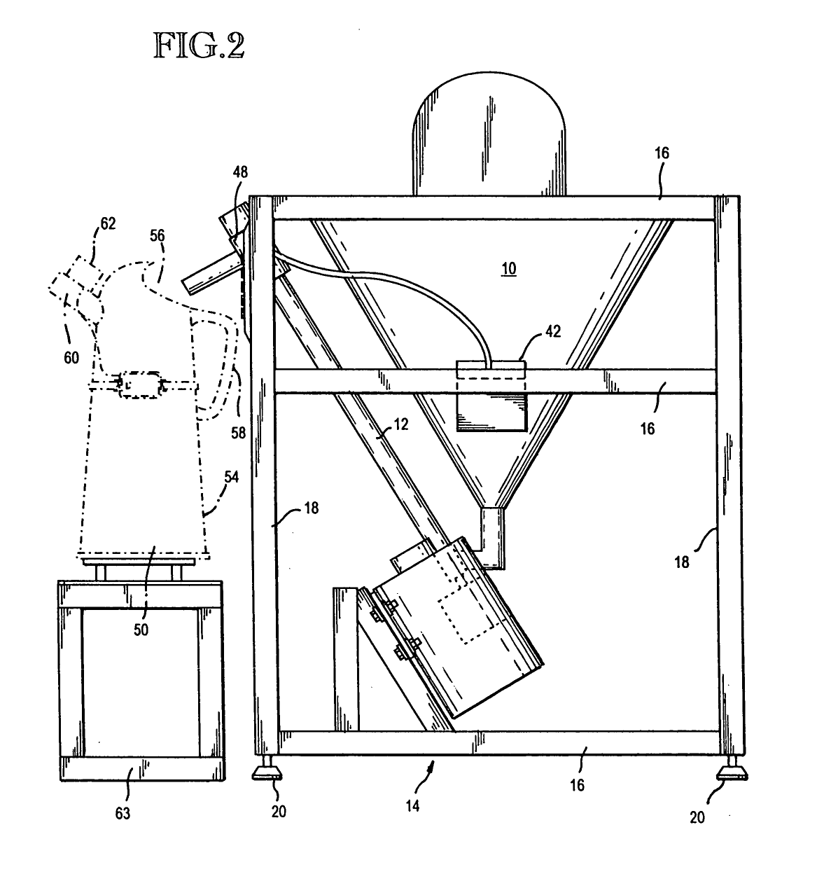

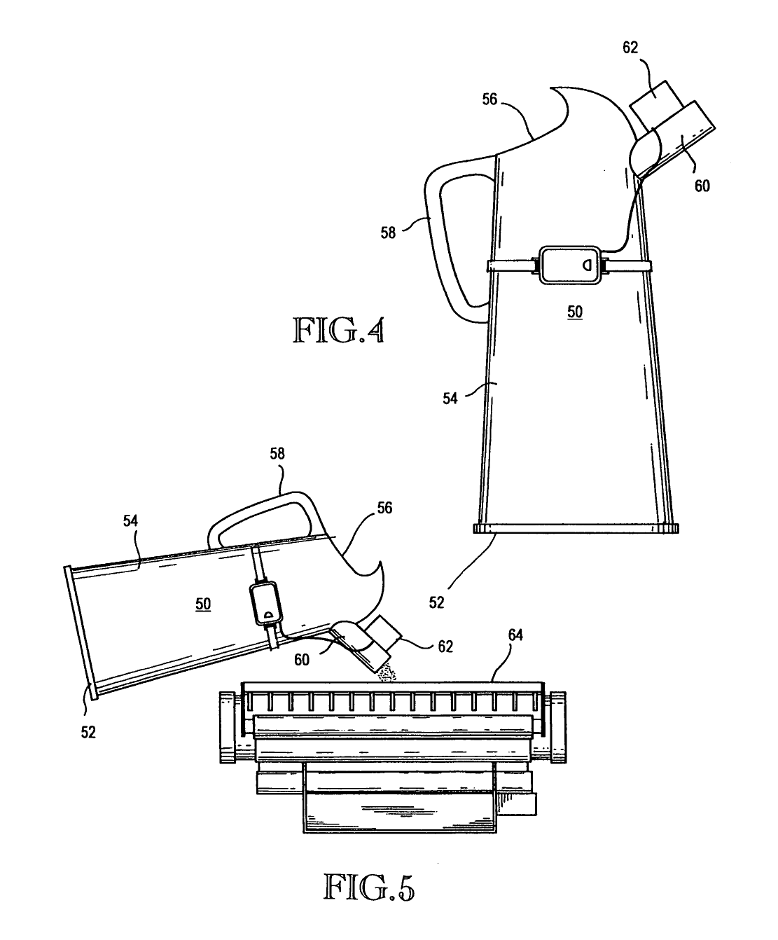

FIGS. 2, 4 and 5 show a pouring container 50 that has a bottom 52, a sidewall 54, an upper end inlet 56, a handle 58 and a pouring spout 60. The pouring spout 60 may be provided with a vibrator 62. When the pouring container 50 is used, its inlet 56 is positioned below and in line with the discharge spout 48. The container 50 is either held under the discharge spout 48 or is positioned on a support stand 63 that is dimensioned to position the container 50 with its inlet 56 adjacent the discharge spout 48, as shown in FIG. 2.

In operation, the conveying screws 28, 34 and the vibrator 42 (FIG. 2), if used, are operated to move toner or other material 44 downwardly through the hopper into the conveying conveyor 32 and upwardly and out from the discharge spout 48, into the inlet 56 of the pouring container 50. When the pouring container 50 is sufficiently full of toner, it is lifted up and moved over to discharge its contents into another container, such as a toner cartridge 64, as shown in FIG. 5. The container 50 is manipulated to position the pouring spout 60 in line with the inlet to the cartridge 64 and the contents of the container 50 is then poured into the container 64. The vibrator 62, when used, will help dispense the toner or other finely divided particular material out from the container 50 into the container 64, while keeping it a substantially compact mass.

In a typical embodiment of the invention, the hopper 10 may measure about 17-20 inches in height and have an inlet diameter about 22 inches and a lower end diameter of about 1% inches. The tube 12 may measure about 1¾ in diameter. The tube 12 may nearly touch the hopper 10 or be spaced very close to it or a few inches away. The other components are scaled accordingly. FIG. 1 shows a control panel that may be mounted on the frame 14. A desirable amount for the drive motor of the elevating conveyor is shown to be mounted on a lower portion of the frame 14. The two vibrators are commercially available units. When they are operating they shake the member on which their mounted to such an extent that the particulate material is compacted and moved substantially as a body.

The illustrated embodiments are only examples of the present invention and, therefore, are non-limitive. It is to be understood that many changes in the particular structure, materials and features of the invention may be made without departing from the spirit and scope of the invention. Therefore, it is my intention that my patent rights not be limited by the particular embodiments that are illustrated and described herein, but rather are to be determined by the following claims, interpreted according to accepted doctrines of patent claim construction, including use of the doctrine of equivalents.

What is claimed is:

1. Apparatus for handling finely divided particulate material, comprising:
a particulate material receiving hopper having an upper end, a lower end and an outlet at its lower end;
an elevating conveyor sideways adjacent the hopper, said elevating conveyor having a lower end, an upper end, an inlet at its lower end, and a discharge spout at its upper end;
a passageway communicating the outlet of the hopper to the inlet of the elevating conveyor; and
said discharge spout on the elevating conveyor being closer to the upper end of the hopper than it is to the lower end of the hopper.

2. The apparatus of claim 1, including a screw in the hopper operable to move particulate material downwardly in the hopper to the outlet of the hopper.

3. The apparatus of claim 1, including a screw in the elevating conveyor rotatable for lifting particulate material upwardly from the inlet of the elevating conveyor to the discharge spout.

4. The apparatus of claim 3, including a conveying screw in the hopper operable to move particulate material downwardly in the hopper to the outlet of the hopper.

5. The apparatus of claim 1, including a vibrator attached to the hopper for vibrating the hopper.

6. The apparatus of claim 2, including a vibrator attached to the hopper for vibrating the hopper.

7. The apparatus of claim 3, including a vibrator attached to the hopper for vibrating the hopper.

8. The apparatus of claim 4, including a vibrator attached to the hopper for vibrating the hopper.

9. The apparatus of claim 1, further comprising a pouring container that is fillable at its top and includes a pouring spout for pouring its contents into another container, said inlet being adapted to receive particulate material discharged from the spout of the elevating conveyor.

10. The apparatus of claim 9, comprising a vibrator attached to the pouring container operable for vibrating the container when pouring particulate material from it into another container.

11. A method of handling finely divided particulate material, comprising:
providing a hopper having a sidewall forming a chamber, an inner end, a lower end and an outlet at the lower end;
providing an elevating container sideways adjacent the hopper, said elevating conveyor having a lower end, an upper end, an inlet at its lower end, and a discharge spout at its upper end;
providing a passageway that communicates the outlet of the hopper to the inlet of the elevating conveyor, said discharge spout on the elevating conveyor being closer to the upper end of the hopper than it is to the lower end of the hopper;
placing particulate material in the hopper;
discharging particulate material downwardly through the hopper, to the outlet of the hopper, through the passageway and into the inlet of the elevating conveyor;
operating the elevating conveyor to elevate the particulate material from the inlet of the elevating conveyor to the discharge spout; and
positioning a receiving container below the discharge spout in a position to receive particulate material that is moved outwardly through the discharge spout in response to operation of the elevating conveyor.

12. The method of claim 11, wherein the particulate material is toner.

13. The method of claim 11, wherein the receiving conveyor placed under the spout is a toner cartridge.

14. The method of claim 11, wherein the receiving container placed under the discharge spout is a pouring container having an inlet at its upper end and a pouring spout.

15. The method of claim 14, comprising operating the apparatus for moving particulate material upwardly through the elevating conveyor and outwardly from the discharge spout on the elevating conveyor, into the inlet of the pouring container, and then pouring the particulate material out from the pouring container into a receiving container.

16. The method of claim 15, wherein the receiving container is a toner cartridge and the particulate material is toner.

17. The method of claim 1, including providing a conveying screw in the hopper for moving particulate material downwardly through the hopper to the outlet of the hopper.

18. The method of claim 11, comprising providing a vibrator on the hopper for vibrating the hopper and assisting downward movement of the particular material in the hopper.

19. The method of claim 11, comprising positioning a conveying screw in the elevating conveyor and operating the conveying screw for moving particulate material upwardly in the elevating conveyor to the discharge spout.

20. The method of claim 19, comprising placing a vibrator on the pouring container and operating the vibrator to vibrate the pouring container while pouring the toner from it into the receiving conveyor.
